(19) United States
(12) Patent Application Publication
(10) Pub. No.: US 2010/0147041 A1
(43) Pub. Date: Jun. 17, 2010

(54) TETHERING ARRANGEMENT FOR PORTABLE ELECTRONIC DEVICES

(75) Inventors: MORDECHAI TEICHER, Hod Hasharon (IL); ITZHAK POMERANTZ, Kfar Saba (IL)

Correspondence Address: TOLER LAW GROUP, 8500 BLUFFSTONE COVE, SUITE A201, AUSTIN, TX, 78759, US

(73) Assignee: SANDISK IL LTD., Kfar Saba (IL)

(21) Appl. No.: 12/336,272

(22) Filed: Dec. 16, 2008

(51) Int. Cl. E05B 73/00

(52) U.S. Cl. 70/58; 710/200

(57) ABSTRACT

In a portable electronic device having an anti-theft functionality and a separate user-operable useful functionality, a method of using the portable electronic device includes operating the user-operable useful functionality; using the anti-theft functionality, wherein using the anti-theft functionality includes inserting an anchor into a socket of the portable electronic device, the anchor being connected to an object separate from the portable electronic device; locking the anchor in the socket to thereby secure the anchor to the portable electronic device; and unlocking the anchor from the socket upon verifying an unlock code that is received at the portable electronic device. The portable electronic device includes a locking mechanism switchable between a locked position in which the anchor is secured to the socket, and an unlocked position in which the anchor is not locked in the socket. The portable electronic device has a processor that is adapted to execute the user-operable useful functionality, receive an unlock code, and to transition the locking mechanism into the unlock position upon verifying the received unlock code.

### FIELD OF THE INVENTION

The present invention generally relates to theft prevention means, and more particularly to portable electronic devices that include a theft prevention means.

### BACKGROUND

Portable electronic devices, such as notebook computers, personal digital assistants (“PDAs”), cellular telephones, text messengers, digital cameras, music and video players, global positioning systems (“GPSs”), USB flash memory devices, and the like, have become very popular. Being relatively expensive and small, portable electronic devices are susceptible to theft. Electronic devices left unattended in shops, malls, restaurant tables, bar counters, office desks, and so on, can be stolen rather easily without the thieving being noticed on the spot. Thieving of such devices has become more common, which is an incentive for devising protection measures.

Various methods have been proposed to solve this problem, which are based on different types of locking mechanisms. In general, prior art solutions teach locking, enclosing, and alarming arrangements for portable computers. Some prior art solutions are designed for a particular device but they cannot be used with other types of devices. For example, prior art solutions teach securing a locking device against one of the walls of a computer casing and tying a steel cable to the locking device and to a stationary object. Such protection means, however, cannot protect smaller portable electronic devices such as a mobile phone or a music player. Other prior art solutions involve using a physical lock which requires carrying an extra lock, and, usually, a key for the lock. Other solutions are inconvenient to implement and use.

Many prior art theft prevention solutions have a common feature, which is their theft-protection function being independent of the operation of the portable electronic device. That is, their locking mechanisms are switched between a locking position and an unlocking position, and vice versa (i.e., depending on the used locking system), by using locking and unlocking commands that originate from, and are effected by, the locking system itself. In other words, the protected portable device is passive with respect to the operation of the locking system. Another drawback of prior art solutions is that they are device-orientated. This means that a protection means is designed to protect one type of portable electronic devices but not other types of portable electronic devices, as explained above in connection with a theft-protection means that can be affixed to a wall of a computer's housing but cannot be used with cellular phones or personal media players. It would, therefore, be beneficial to have a portable electronic device with an integral locking mechanism that has both a user useful functionality, such as playing media files, sending text messages, and so on, and an anti-theft functionality that can be executed internally; i.e., by the portable electronic device itself.

### SUMMARY

By “portable electronic device” is meant herein, but not limited to, a notebook computer, personal digital assistant (“PDA”), mobile telephone, text messenger, digital camera, music player, global positioning system (“GPS”), USB flash memory device, and the like. An “object” refers herein to an object (e.g., a desk or a workstation) that is separate from the portable electronic device and is relatively hard to move around or is impossible to move without destroying or damaging it. The present invention secures a portable electronic device to an object in order to deter theft of the portable electronic device. The following embodiments and aspects thereof are described and illustrated in conjunction with systems, tools, and methods, which are meant to be exemplary and illustrative but not limiting in scope.

As part of the present disclosure a portable electronic device is provided, which is securable to an anchor that is connectable, or is actually connected, to an object for anti-theft protection, the portable electronic device including a processor that handles both a user-operable useful functionality, which usually is associated with service(s) rendered by the portable electronic device (e.g., calling someone else, sending text messages, playing music, etc.), and an anti-theft functionality. The portable electronic device also includes an anti-theft application that, together with an embedded controllable locking mechanism, renders the anti-theft functionality. The user-operable useful functionality is disassociated from the locking mechanism and from the anti-theft functionality in general. The locking mechanism, which is switchable between a locked position and an unlocked position, includes a socket to which the anchor can be mechanically secured or retained when the locking mechanism is in the locked position, and from which the anchor can be removed or unsecured when the locking mechanism is in the unlocked position; and a latch controllable by the processor to implement the unlocked position.

Responsive to receiving a valid unlock code via a user interface that is built into the portable electronic device, or from a host device that is connected to the portable electronic device, or via a wired or wireless communication network, the anti-theft application causes the processor to transition the locking mechanism into the unlocked position.

The anchor may be rigidly connected to, or it may be part of, the object, or the anchor may be secured to the object by means of a cable, the physical integrity of which may be monitored by the portable electronic device's processor, for example by using an electric wire that goes through the cable from one of its ends to the cable's other end. The anchor may consist of a first part and a second part that are each adapted to accommodate a cable end. The anchor's first part and the anchor's second part are adapted to be jointly engaged with, and jointly disengaged from, the socket.

### BRIEF DESCRIPTION OF THE DRAWINGS

Exemplary embodiments are illustrated in referenced figures. It is intended that the embodiments disclosed herein are illustrative rather than restrictive. The disclosure, however, may better be understood with reference to the following detailed description when read with the accompanying figures, in which:

FIGS. 1A and 1B show a tethering arrangement according to an exemplary embodiment;

FIG. 2 shows a tethering arrangement according to another exemplary embodiment;

FIGS. 3A, 3B, and 3C show a tethering arrangement according to yet another exemplary embodiment;

FIGS. 4A, 4B, 4C, 4D and 4E schematically illustrate a UFD device with a locking mechanism according an exemplary embodiment;

FIG. 5 shows a portable electronic device that is tethered according to an exemplary embodiment;

FIGS. 6A and 6B schematically illustrate securing a portable electronic device to a rigid anchor according to an exemplary embodiment;

FIG. 7 shows a tethering arrangement according to an exemplary embodiment;

FIGS. 8A and 8B schematically illustrate an anchor and a locking mechanism according to an exemplary embodiment;

FIG. 9 shows an operation sub-application according to an exemplary embodiment;

FIG. 10 shows an unlock sub-application according to an exemplary embodiment;

FIG. 11 schematically illustrates a host's unlock application stack and a UFD device's unlock application stack according to an example embodiment;

FIG. 12 schematically illustrates a mobile phone's operating system architecture according to an example embodiment; and

FIG. 13 schematically illustrates a mobile phone's unlock application stack according to an example embodiment.

It will be appreciated that for simplicity and clarity of illustration, elements shown in the figures are not necessarily drawn to scale. Further, where considered appropriate, reference numerals may be repeated among the figures to indicate like, corresponding or analogous elements.

### DETAILED DESCRIPTION

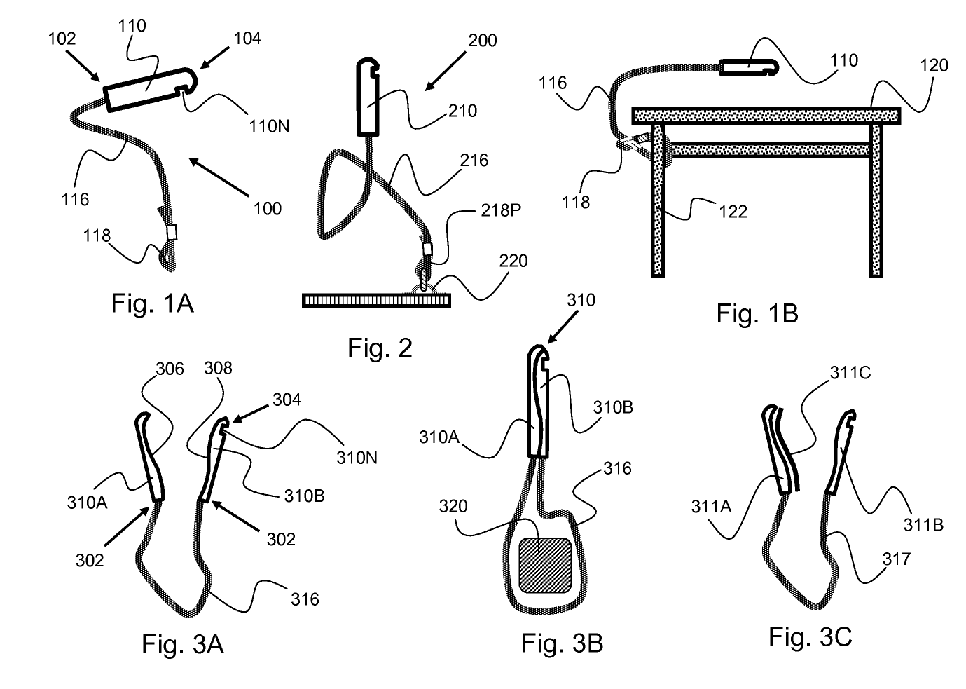

FIG. 1A illustrates a tethering system 100 according to an exemplary embodiment. Tethering system 100 includes an anchor 110 and a cable 116. Anchor 110 includes a retaining portion 102 for retaining anchor 110, and a lockable portion 104. Lockable portion 104 of anchor 110 is adapted to be locked by a locking mechanism (not shown in FIG. 1A) of the portable electronic device, and more specifically, to be secured to, or retained within, a socket (not shown in FIG. 1A) concealed in the portable electronic device.

Retaining portion 102 of anchor 110 is connected to an end of cable 116, the other end of which forms a loop 118 where anchor 110 can be passed through. Cable loop 118 is yet small enough not to allow a secured portable electronic device to pass therethrough. Lockable portion 104 may include a groove or a notch (shown at 110N) into which a latch bolt, which is part of the locking mechanism, can enter.

FIG. 1B illustrates tethering cable 116 of FIG. 1A tied, or retained, to an object 120 (which in this example is a desk) by having tethering cable 116 wounded around leg 122 of desk 120. A portable electronic device (not shown in FIG. 1B) can be secured to desk 120 either by securing anchor 110 to the portable electronic device and then securing cable 116 to the desk leg 122 (for example) by using loop 118, or by first securing tethering cable 116 to desk 120 and then securing portable electronic device to anchor 110.

FIG. 2 illustrates a tethering arrangement 200 according to another exemplary embodiment. In this embodiment, an anchor 210 is permanently retained to an object 220 via a cable 216, which is permanently connected to an object 220 via a tie loop 218P. An object such as desk 120 of FIG. 1B may include a docking point similar to object 220 of FIG. 2. Docking points such as object 220 may be offered in bars to customers to allow them to secure their cellular telephone or other portable electronic devices.

FIG. 3A illustrates a two-part anchor according to another exemplary embodiment. The two-part anchor consists of two separate parts: a first part 310A and a second part 310B. Part 310A and part 310B each includes a retaining portion 302. Retaining portion 302 of anchor part 310A is connected to one end of a cable 316 and retaining portion 302 of anchor part 310B is connected to the other end of cable 316. Part 310B is shown having an exemplary lockable portion 304. Although shown in FIG. 3A as not having a lockable portion, in other embodiments part 310A may also have a lockable portion.

For security reason, first part 310A and second part 310B are adapted to be jointly engaged with, and jointly disengaged from, the socket of a portable electronic device. This way, one part of the anchor will help securing the other part of the anchor in place in the socket. This feature is useful in particular if only one part of the anchor has a lockable portion, as demonstrated in FIG. 3A where only anchor part 310B has a groove or notch (i.e., 310N).

To facilitate the engagement of the two-part anchor with an anchor receiving module (not shown in FIG. 3A), anchor parts 310A and 310B have to be joined together, as demonstrated in FIG. 3B, before the engagement actually takes place. To prevent the removal of one part (e.g., part 310A) while the other part (e.g., part 310B) still resides within a socket, anchor part 310A may have a concave surface such as concave surface 306, and anchor part 310B may have a matching convex surface such as convex surface 308 that snuggly fits onto the concave surface of anchor part 310A. Alternatively or additionally surfaces 306 and 308 may be serrated. Alternatively or additionally, one surface, for example surface 306, may have a groove or bore, and the other surface (e.g., surface 308) may have a protruding member that snugly fits into the groove or bore before the anchor is engaged with the socket. Because of surfaces 306 and 308, the two-part anchor can be engaged with, and disengaged from the socket only jointly, as one body. FIG. 3B shows anchor parts 310A and 310B joined together, and object 320 being embraced by cable 316. Anchor parts 310A and 310B are inseparable while in the socket (not shown in FIGS. 3A and 3B) and separable only after they are jointly removed from the socket.

FIG. 3C illustrates a two-part anchor according to another exemplary embodiment. The two-part anchor of FIG. 3C includes a first part 311A and a second part 311B. First part 311A and second part 311B are interconnected via a tethering cable 317. Cable 317 may internally include a concealed electric wire (not shown in FIG. 3C) to facilitate monitoring of the physical integrity of cable 317 by the protected portable electronic device; that is, to facilitate detection, by the secured portable electronic device, of a security breach. The secured portable electronic device may respond to detected security breach in the following manner. If the electric wire within cable 317 is entirely cut off, the portable electronic device may electronically lock itself to prevent an unauthorized person from using it and, in addition, it may trigger an audible or silent alarm. If the electric wire embedded within cable 317 is damaged but not cut off, the secured portable electronic device may display a message to the authorized user that an attempted theft occurred and, in addition, it may trigger an alarm. Unlocking the portable electronic device may then be effected only by using an unlock code or password that is known to the portable electronic device owner or authorized user, or by using biometric data (e.g., a fingerprint) of the authorized user. A damaged cable will have to be replaced by a new cable.

Cutting off of an electric wire may be detected by the protected portable electronic device by closing an electric circuit via the electric wire concealed within cable 317. Detecting a damaged electric wire may be done by the portable electronic device using Time Domain Reflectometry (“TDR”), for example. Briefly, “TDR” is a technique that helps determining the characteristics of electric lines by transmitting waveforms and observing reflected waveforms. The characteristics of electric lines are greatly affected by the impedance of discontinuities therein, which change the amplitude of reflected signals. The distance to a reflecting impedance can also be determined from the time it takes a transmitted pulse to reach the discontinuity and to return to the transmitting end. Because damaging the electric wire within cable 317 would form a discontinuity therein, the fact that cable 317 has been damaged can be detected using the TDR technique. An electrically-insulating layer 311C isolates first part 311A from second part 311B when both parts are jointly engaged with the socket within the portable electronic device. With respect to the exemplary embodiments of FIGS. 1A, 1B, 2, and 3A through 3C, a tethered portable electronic device may be operated normally if cables 116, 216 and 317 are sufficiently long and flexible. By “may be operated normally” is meant that a user of the involved portable electronic device may use the portable electronic device to operate a user-operable useful functionality (for example to send a text message or to listen to music), which is disassociated from an anti theft functionality of the portable electronic device.

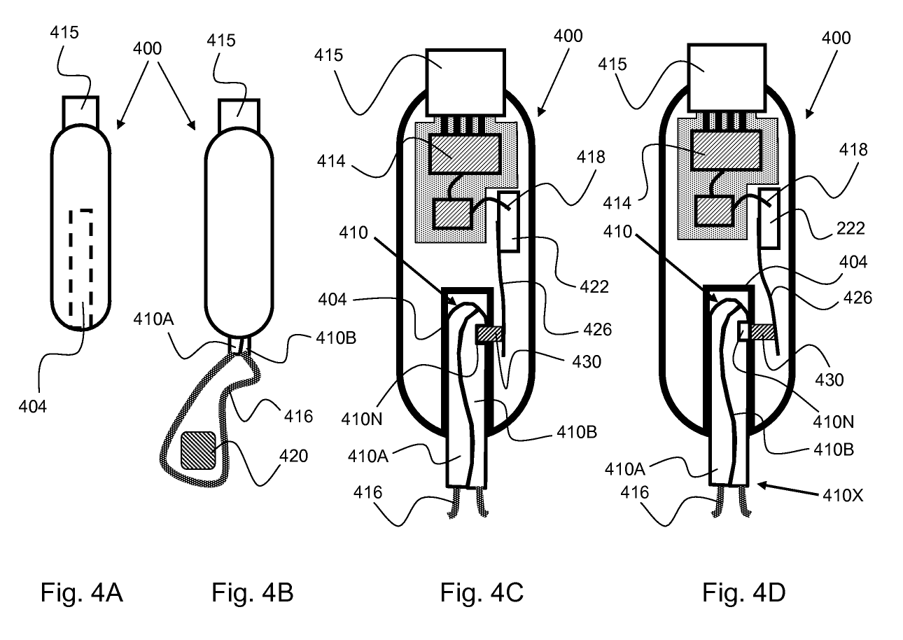

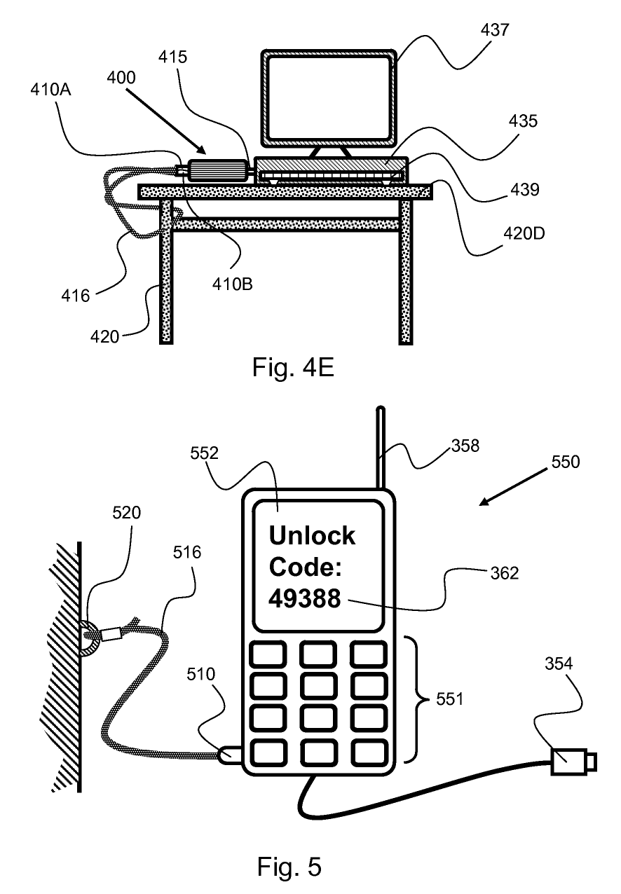

FIGS. 4A, 4B, 4C and 4D schematically illustrate a USB flash drive (“UFD”) 400 as an exemplary portable electronic device. Referring to FIG. 4A, UFD 400 has a USB connector 415. UFD 400 includes a locking mechanism for releasably locking an anchor such as anchor 110 of FIG. 1A, two-part anchor 310 of FIG. 3B, or two-part anchor 311 of FIG. 3C. The locking mechanism includes a socket 404 (shown in FIG. 4A in a dashed line) that is designed or adapted to receive and accommodate the anchor.

FIG. 4B shows UFD 400 of FIG. 4A tethered to an object 420 by a tethering arrangement that includes a two-part anchor and a cable 416. The two-part anchor may be identical or similar, for example, to the two-part anchor shown in FIG. 3B. The two-part anchor of FIG. 4B includes a first anchor part 410A and a second anchor part 410B which are shown jointly residing within socket 404 (not shown in FIG. 4B). The retaining portions of first part 410A and second part 410B are shown in FIG. 4B connected to a common cable (i.e., to cable 416). The locking portions of first part 410A and second part 410B are hidden inside UFD 400.

FIG. 4C shows anchor 410 of FIG. 4B residing within socket 404. A notch 410N is locked against socket 404. A bi-metal strip 426 serves as an electrically-controlled actuator for pulling a locking bolt 430 from notch 410N. A support member 422 provides mechanical support to bi-metal strip 426. FIG. 4C shows locking bolt 430 and notch 410N engaged, in which state anchor 410 is secured to socket 400 of UFD 400. Anchor 410 may be secured to socket 404 manually by using bi-metal strip 426 as a spring; that is, by pushing anchor 410 inside socket 404 against latch bolt 430, to cause, thereby, the curved surface of a lockable portion of anchor 410 to push latch bolt 430 sidewise (rightward in FIG. 4C) until notch 410N faces latch bolt 430. When notch 410N faces latch bolt 430, bi-metal strip 426 pushes latch bolt 430 into notch 410N, thereby securing anchor 410 to socket 404.

By connecting connector 415 to a host device (e.g., a laptop), an anti-theft application executed by a USB controller 414 can receive an unlock command from the host device via USB connector 415. If the anti-theft application determines that a received unlock code is valid, the anti-theft application causes controller 414 to send an electric current, through an electric wire 418, to bi-metal strip 426. Responsive to the heat generated in the bi-metal strip 426 by the electric current, bi-metal strip 426 bends “away” from notch 410N, thereby disengaging locking bolt 430 from notch 410N to allow anchor 410 to be manually removed from socket 404.

FIG. 4D shows locking bolt 430 and notch 410N of FIG. 4C disengaged, in which state anchor 410 is removable from UFD 400 by the user pulling a retention portion 410X of anchor 410. A locking mechanism may include, by way of example, a bi-metal strip such as bi-metal strip 426 and a latch bolt such as latch bolt 430. However, a locking mechanism may include different elements, substitute elements, or additional elements. For example, an alternative locking mechanism may include a solenoid for pulling a locking bolt away from notch 410N.

FIG. 4E shows UFD 400 of FIGS. 4A through 4D tethered to a desk 420D. UFD 400 is shown in FIG. 4E connected to a personal computer (PC) 435. PC 435 is placed on desk 420D. USB connector 415 of UFD 400 resides within a USB socket of PC 435 and UFD 400 is retained to leg 420 by using a tethering arrangement that includes a cable 416 and a two-part anchor that includes first part 410A and second part 410B.

UFD 400 does not have a user interface. Therefore, UFD 400 can be released from the two-part anchor 410 by using a host device, such as PC 435 that has a user interface and an anti-theft application. The anti-theft application, though, may reside on, and executed by, UFD 400. When a user enters an unlock code by using a keyboard 439 and a display screen 437, the validity of the unlocking code is checked by the anti-theft application which, as mentioned above, may reside in PC 435 or in UFD 400. If the anti-theft application determines that the unlocking code is valid anchor parts 410A and 410B are unlocked, for example by pulling a latch bolt, such as latch bolt 430 of FIG. 4D, from a groove or notch of the anchor. The latch bolt may be pulled out from the groove or notch of the anchor as a result of an electric current being provided by PC 435 to a bi-metal strip in UFD 400 through USB connector 415. Depending on the anti-theft configuration, some modules of the anti-theft application may reside in the host device (for example in PC 435) and other modules may reside in UFD 400. That is, the anti-theft application may be distributed between the portable electronic device (e.g., UFD 400) and the host device (e.g., PC 435).

The embodiment demonstrated in FIGS. 4A through 4E requires another device (in FIG. 4E it is PC 435) to unlock UFD 400. However, as described below in connection with other exemplary embodiments, portable electronic devices can have a locking mechanism, a user interface suitable for entering an unlock code, and an anti-theft application for checking an unlock code entered via the user interface and for controlling the locking mechanism accordingly.

FIG. 5 illustrates a tethering arrangement according to another exemplary embodiment. A cellular phone 550, which is an exemplary portable electronic device, is tethered to an object 520 by an anchor 510 and a cable 516. An electronic device includes a processor for executing a “primary” function. The primary function of phones such as cellular phone 550 is typically to enable communication with other persons that use like devices, exchanging of text messages, and so on. Accordingly, the primary function of portable electronic devices, of which cellular phone 550 is an example, is herein referred to as a “user-operable useful functionality”. However, according to the present disclosure portable electronic devices have an additional functionality, which is operating an anti-theft functionality that is disassociated from (i.e., it is separated from or independent of) the user-operable useful functionality. Cellular telephone 550 also includes a socket, which may be similar or identical to the socket described in connection with FIGS. 4C and 4D, and a power supply (both not shown in FIG. 5) for powering cellular phone 550.

In respect of FIG. 5, the anti-theft functionality involves checking unlock codes that are received at cellular phone 550 (e.g., via a keypad 551 or an antenna 358), and controlling a locking mechanism inside cellular phone 550 based on the checked unlock code. More specifically, the anti-theft functionality involves releasing, or unsecuring, cellular phone 550 from anchor 510 upon receiving a proper (i.e., valid) unlock code. An unlock code may be entered into cellular phone 550 by using: (a) a user interface that may include the phone's keypad 551 and display screen 552, or (b) a connector 354 that can be connected to a host device such as a PC, via which the user can enter an unlock code; or (c) antenna 358, via which the unlocking command may be entered remotely, for example by another cellular phone. The number “49388” (shown at 362) is an exemplary unlock code.

An unlock code can be a code or password that is known only to the authorized user (for example unlock code “49388”, shown at 362), or something that is unique to the authorized user, such as a biometric parameter (for example, a fingerprint). Most, if not all, of the cellular phones allow their users to lock the keyboard and unlock it by using a password. Assuming that a phone user unlocking keypad 551 of cellular phone 550 wants to use cellular phone 550, for example to make a call, the same password may be used for untethering cellular phone 550, to avoid using an additional password. In cases where the same password is used both for untethering cellular phone 550 and for conventionally unlocking keypad 551, the password may be used once; i.e., to untether cellular phone 550 and to release keypad 551 at the same time, or twice, to first untether cellular phone 550 and, then, to release keypad 551. The code usage order can be reversed; i.e., the password may be used to first release the phone's keyboard and, then, to untether the cellular phone.

Anchor 510 and tethering cable 516 may include a concealed electric wire to facilitate monitoring (continually, intermittently, or occasionally) of the cable's physical integrity by cellular phone 550, for example by monitoring the resistance of the concealed electric wire, or by closing a current loop via the concealed electric wire, or by using TDR measurements. If an anti-theft application running on cellular phone 550 is adapted to monitor the physical integrity of tethering cable 516, various types of alarms could be triggered, depending, for example, on whether the tethering cable was cut off or damaged. Cellular phone 550 may trigger an alarm if the cable integrity is compromised. The anti-theft application may monitor the physical integrity of tethering cable 516 by closing a loop of a relatively low electric current (e.g., several microamperes) through the concealed electric wire, and sensing the returning electric current. Unexpected cessation of the electric current passing through the concealed electric wire will indicate to the anti-theft application that the tethering cable has been cut off. Responsive to such indication (i.e., the tethering cable has been cut off) the anti-theft application may lock keypad 551 of cellular phone 550 and, alternatively or additionally, transmit an alarm to another cellular phone (for example).

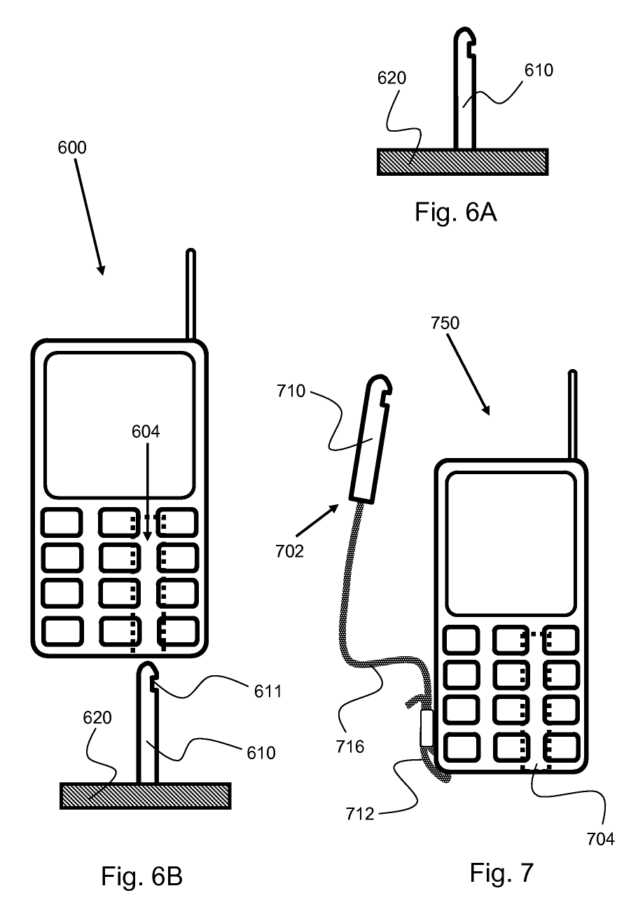

Using a cable such as cable 516 with sufficient length and flexibility allows using a user of cellular phone 550 to conveniently operate the user-operable useful functionality even while cellular phone 550 is tethered. A cable, on the other hand, may be easy to cut. Therefore, it may be safer to retain a portable electronic device to an anchor that is rigidly affixed to a stationary object, as demonstrated in FIGS. 6A and 6B.

FIG. 6A illustrates an anchor 610 according to another exemplary embodiment. Anchor 610 is rigidly affixed to a stationary object 620, which may be part of a desk or a wall. FIG. 6B shows an exemplary portable electronic device 600 before it is secured to anchor 610. Securing portable electronic device 600 to anchor 610 is done by inserting anchor 610 into socket 604 (shown in FIG. 6B in dashed line) and latching notch or groove 611 by a latch of a locking mechanism (not shown in FIG. 6B) that is built into, or is an integral part of, portable electronic device 600. Latching notch 611 can be done by pushing socket 604 of portable electronic device 600 against anchor 610 and causing anchor 610 to lock itself inside socket 604 by actuating a latch bolt.

FIG. 7 illustrates a tethering arrangement according to another exemplary embodiment. Exemplary portable electronic device 750, which in this example is a cellular telephone, has a socket 704 for accommodating an anchor 710. Anchor 710 has a retaining portion 702 that is connected to a first end of a cable 716. The second end of cable 716 is fixedly tied (shown at 712) to the body of portable electronic device 750 by a tie loop 712. In order to secure portable electronic device 750 to an object such as desk leg 122 of desk 120 of FIG. 1B, cable 716 has to be winded around (i.e., the cable has to embrace) an object and, thereafter, anchor 710 has to be inserted into socket 704 and locked inside portable electronic device 750 by a locking mechanism (not shown in FIG. 7) that is built into, or is an integral part of portable electronic device 750.

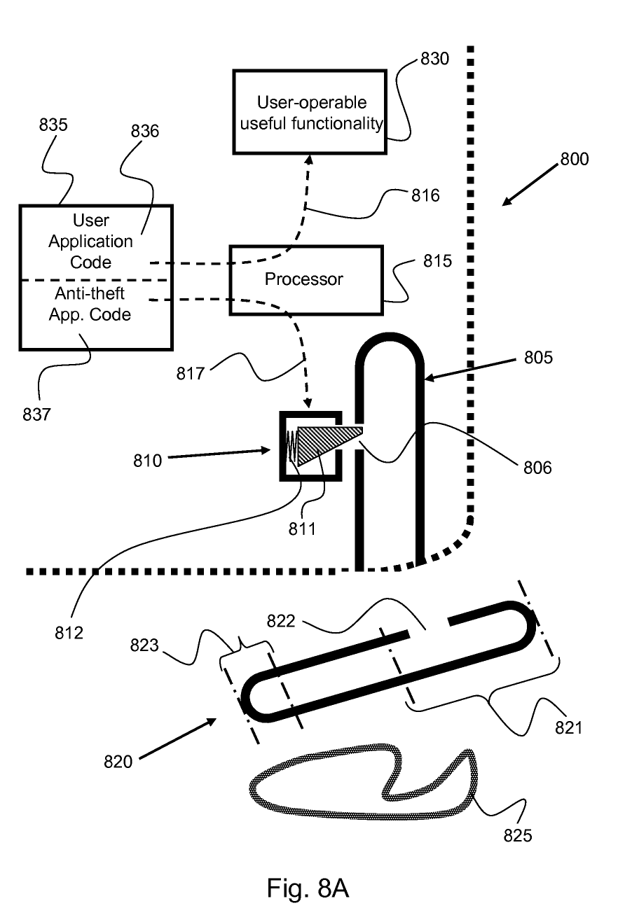

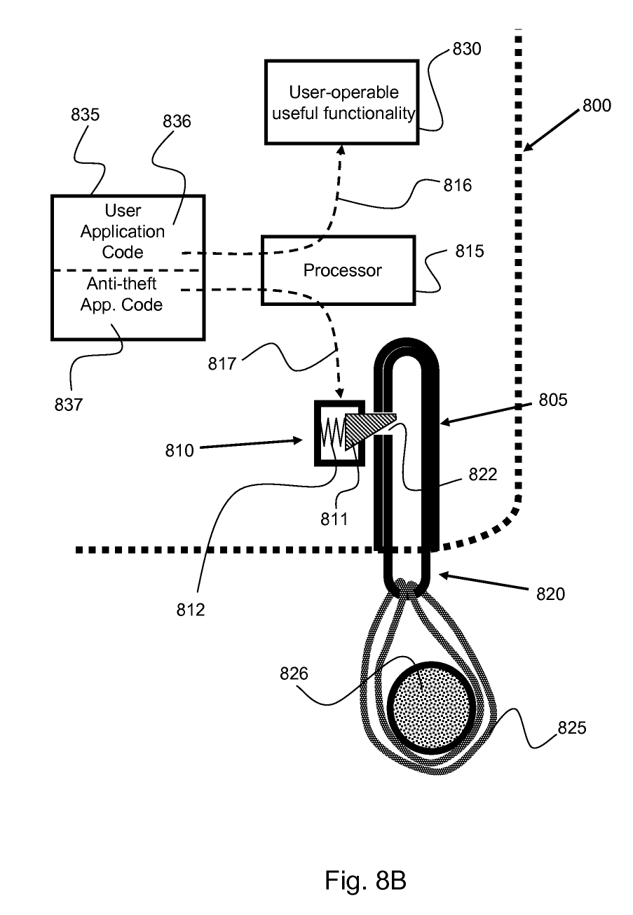

FIGS. 8A and 8B illustrate a tethering arrangement according to another exemplary embodiment. FIG. 8A shows, in part, an exemplary portable electronic device 800 that includes an exemplary locking mechanism. The locking mechanism includes a socket 805 for accommodating an anchor 820, and a latch mechanism (generally shown at 810) for securing anchor 820 in socket 805. Latch mechanism 810 is switchable between a locked position, in which position anchor 820 can be secured to, locked inside, or retained against socket 805, and an unlocked position, in which position anchor 820 becomes unsecured and removable from socket 805. Latch mechanism 810 is shown in FIG. 8A in unlocked position.

Portable electronic device 800 also includes a processor 815 and a non-volatile memory (“NVM”) 835. NVM 835 may be a flash memory device. NVM 835 conventionally holds a user application code 836 that, when executed (shown at 816) by processor 815, allows a user of portable electronic device 800 to operate a user-useful functionality 830.

User application code 836 depends, among other things, on the type of portable electronic device 800 and on the type of services rendered by portable electronic device 800. For example, if portable electronic device 800 is a cellular phone, the user application code 836 may, in general, pertain to services rendered by the cellular phone's service provider, phone lists, pictures, video and music files, and so on, and user-useful functionality 830 may include talking to another person, sending a text message, listening to music, taking and watching pictures and video clips, sending e-mails, and so on. If portable electronic device 800 is a laptop computer, user application code 836 may pertain to every application running on, or executed by, the laptop's processor, to Microsoft “WORD” files, and so on.

In accordance with the present disclosure, NVM 835 holds an anti-theft application code 837 that, when executed (symbolically shown at 817) by processor 815, activates an anti-theft functionality, by operating latch mechanism 810. The anti-theft functionality is disassociated from user-operable useful functionality 830. According to one exemplary embodiment, responsive to entering, by an operator of portable electronic device 800, a valid unlock code anti-theft application code 837 causes processor 815 to transition latch mechanism 810 from locked position into unlocked position and, responsive to entering, by an operator of portable electronic device 800, a valid lock code, anti-theft application code 837 causes processor 815 to transition latch mechanism 810 from unlocked position into locked position. According to another exemplary embodiment anchor 820 is locked manually in socket 805 and anti-theft application code 837 causes processor 815 to only transition latch mechanism 810 from locking position into unlocking position, to unlock the anchor. Processor 815 may forward control signals to latch mechanism 810 to transition latch mechanism 810 from one position to another responsive to unlock and (depending on the application) lock codes or passwords that may be entered by the operator of portable electronic device 800, for example, via a user interface (not shown in FIGS. 8A and 8B) that is part of portable electronic device 800. NVM 835 may hold unlocking and (depending on the application) locking codes or passwords or data related to such codes or passwords, biometric data, and, in general, any data or information that is required by processor 815 to control the operation of latch mechanism 810 and to enable user-operable useful functionality 830. Portable electronic device 800 may be securely tethered to an object by using a tethering kit that may include an office clip-shaped anchor such as anchor 820, and a cable such as cable 825.

Latch mechanism 810 includes a latch 811, which may be actuated by any suitable actuator. For example, the actuator may include a spring such as spring 812, that pushes latch 811 “outwardly” through an opening 806 in socket 805. Latch mechanism 810 is shown in FIG. 8A in unlocked position because latch 811 is retracted to allow an anchor, such as anchor 820, to be inserted into socket 805. In the unlocked position spring 812 is in compressed state. Latch 811 may initially be in a retracted state for making room in socket 805 for anchor 820, and after anchor 820 is inserted into socket 805, a locking command, or locking signal, may be forwarded by processor 815 to latch mechanism 810 to cause latch 811 to extend.

Latch 811 may initially be in extended state and pushed by anchor 820 against spring 812 (i.e., to the “retracted” state) as anchor 820 is manually inserted into socket 805. Anchor 820 has a lockable portion 821 that includes an opening 822 by which anchor 820 can be locked by latch 811 inside socket 805, and a retaining portion 823 by which anchor 820 can be tied to an object. To secure anchor 820 to socket 805, anchor 820 has to be inserted into socket 805 while the anchor's opening 822 faces the socket's opening 806, so that latch 811 can extend also through anchor opening 822, as demonstrated in FIG. 8B, to thereby lock anchor 820 inside socket 805.

FIG. 8B shows portable electronic device 800 of FIG. 8A secured to an object 826. Anchor 820 is shown inserted into socket 805 and locked by latch 811 of latch mechanism 810. Anchor 820 cannot be removed from socket 805 because latch 811 extends through the opening 822 and, thus, obstructs the removal of anchor 820 from socket 805. Anchor 820 is tied to object 826 by cable 825, which can be removed through anchor's opening 822 only after anchor 820 is unlocked and removed from socket 805. Spring 812 is shown in FIG. 8B in released (“uncompressed”) state. Releasing anchor 820 is executed by the operator of portable electronic device 800 entering an unlock code or password and, responsive to a correct unlock code or password being entered, causing processor 815 to forward to latch mechanism 810 an unlock command or control signal that will cause latch 811 to withdraw or retract from opening 822. Retracting latch 811 can be implemented in various ways, for example by using a bi-metal strip or a solenoid (both not shown in FIG. 8B for simplicity).

In order to facilitate the anti-theft methodology disclosed herein (i) portable electronic devices may contain a corresponding software application, for example after downloading the software application from a remote resource, (ii) the portable electronic device's lock/unlock mechanism can be configured to generate and transfer an interrupt signal to the portable electronic device if the tethering cable securing the portable electronic device is cut off or the anchor is tampered with, (iii) the software application can instruct a higher-level application of the portable electronic device to enable the anti-theft service (i.e., the second functionality) or to disable that service, and (iv) the software application can generate and transfer a signal to the locking mechanism to actuate a latch in order to unlock a locked anchor. Loading applications, generating an interrupt signal, exchanging messages between an application and a higher-level application and sending a control signal to actuate a latch of a locking mechanism can be implemented using any method known to those skilled in the art.

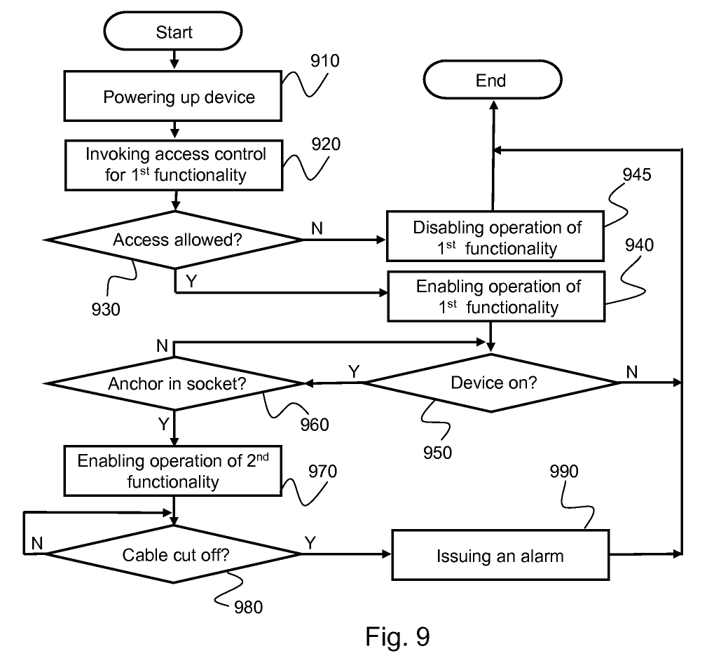

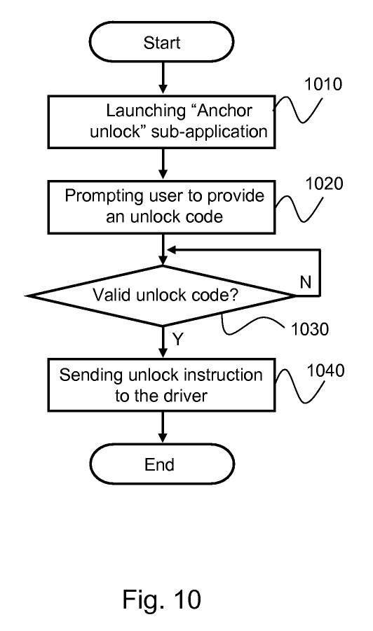

The software application that facilitates the anti-theft methodology may be consisted of, or use, two sub-applications: an “operation” sub-application, which is described below in connection with FIG. 9, and an “unlock” sub-application, which is described below in connection with FIG. 10. In general, the operation sub-application may handle two situations: (1) a situation where an anchor is locked inside a socket of the portable electronic device, and (2) a situation where no anchor is locked in the socket. In general, the unlock sub-application may check an unlock code and instructs the portable electronic device to unlock the anchor upon receiving a valid unlock code.

FIG. 9 shows an operation sub-application according to an exemplary embodiment. FIG. 9 will be described in association with FIG. 7. At step 910, portable electronic device 750 is powered up. At step 920, portable electronic device 750 invokes an access control application to allow a user of portable electronic device 750 to enter an access code or password in order to invoke the first functionality of portable electronic device 750.

At step 930 it is checked whether the access code or password entered by the user is valid. If the code or password entered by the user is invalid, access to the first functionality is disallowed (shown as “N” at step 930) and operation of the first functionality is disabled at step 945. If, however, the code or password entered by the user is valid (shown as “Y” at step 930), operation of the first functionality is enabled at step 940. If portable electronic device 750 is “on” (shown as “Y” at step 950), it is checked at step 960 whether there is an anchor in socket 704 of portable electronic device 750. If there is no anchor in socket 704 (shown as “N” at step 960), step 960 is repeated while electronic device 600 is “on”. However, if there is an anchor in socket 704 (shown as “Y” at step 960), operation of the second functionality is enabled at step 970. Assuming that portable electronic device 750 is tethered by cable 716 and anchor 710 to a stationary subject, the second functionality checks at step 980 whether cable 716 is cut off. If cable 716 is cut off (shown as “Y” at step 980), the second functionality may issue an alarm at step 990. Alternatively or additionally to issuing the alarm at step 990, the second functionality may perform a preset alarm-related activity, for example switching off portable electronic device 750, locking the device's keypad, etc.

FIG. 10 shows an unlock sub-application according to an exemplary embodiment. FIG. 10 will be described in association with FIG. 5. It is assumed that anchor 510 is currently locked in the socket of cellular phone 550 and the user of cellular phone 550 wants to unlock it. In order to unlock anchor 510 the user of cellular phone 550 launches, at step 1010, an unlock sub-application on cellular phone 550 and at step 1020 the launched unlock sub-application prompts the user to enter/provide a corresponding unlock code. The unlock sub-application may be launched automatically by the insertion of anchor 510 into the socket of cellular phone 550. In order to facilitate automatic launch of the unlock sub-application, the socket of cellular phone 550 may include a micro switch that, when actuated by the anchor inserted into the socket, invokes the unlock sub-application.

Entering the unlock code to cellular phone 550 may be performed either locally, by using keypad 551, or remotely, by transmitting the unlock code to antenna 358 or by transferring the unlock code to cellular phone 550 via connector 354. Alternatively or additionally, biometric data may be provided by the user to cellular phone 550 to unlock the anchor, where the biometric data may represent, for example, the user's fingerprint. Cellular phone 550 may be provided with biometric sensors to receive such data.

At step 1030 it is checked by the unlock sub-application whether the unlock code or biometric data, or both (whichever the case may be), is/are valid. If the unlock code and/or biometric data are/is valid (shown as “Y” at step 1030), the unlock sub-application issues, at step 1040, an unlock instruction that is translated into a corresponding unlock signal that is provided to the locking mechanism to unlock anchor 510. The unlock sub-application unlocks anchor 510 by transitioning the locking mechanism (not shown in FIG. 5) of cellular phone 550 from the locked position into the unlocked position.

The user may be granted one or more (i.e., up to N) attempts to enter a valid unlock code. Accordingly, if the user enters an invalid unlock code or provides an invalid biometric data to unlock anchor 510 (shown as “N” at step 1030) the anchor remains locked and the user may be allowed to try once more to unlock anchor 510. If the user fails to provide the correct unlock code N consecutive times anchor 510 remains locked inside cellular phone 550 and, optionally, an alarm may be triggered. Depending on the anti-theft application, a special (i.e., a second, a “bypass”, or a “master”) code may be used to free anchor 510 after an incorrect unlocking code has been provided N consecutive times. N may equal 1.

### Tethering a USB Device

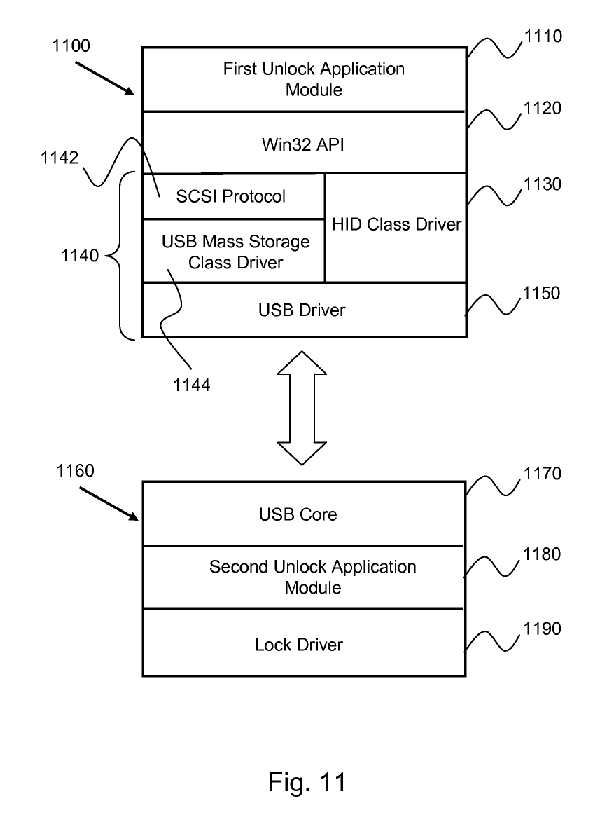

Referring again to FIG. 4E, UFD 400 does not have a user interface. Therefore, the user needs another device, for example user interface of PC 435 (e.g., keyboard 439) for entering an unlock code. The anti-theft application, which may be, or include, an unlock application, may wholly reside in UFD 400 or in PC 435, or it may be distributed between the devices. An exemplary UFD unlock module stack is shown in FIG. 11, which is described below.

FIG. 11 schematically illustrates an unlock application stack of a host 1100 and an unlock application stack of a UFD device 1160 according to an example embodiment. The anti-theft application described above (for example in connection with FIG. 8B) may be distributed between host 1100 and UFD 1160, the distribution of the anti-theft application being shown in FIG. 11 by host 1100 including a first Unlock Application Module 1110 and UFD device 1160 including a second Unlock Application Module 1180.

Unlock Application Module 1110 handles an unlock code entered by the user of UFD device 1160, including forwarding the entered unlock code, or a derivative or a modified version thereof (e.g., a corresponding hash value), to UFD device 1160. For example, Unlock Application Module 1110 may receive the unlock code from a keyboard or keypad of host 1100, use a hash function to hash the unlock code and forward the resulting hash value corresponding to the unlock code to UFD device 1160 via USB driver 1150. Briefly, “hash function” is a procedure or mathematical function which converts a large, possibly variable-sized amount of data into a small datum. The values returned by a hash function are called hash values, hash codes, hash sums, or simply hashes. Unlock Application Module 1180 compares the hash value it receives from Unlock Application Module 1110 to a hash value that is pre-stored on UFD device 11160.

Host 1110 also includes a USB interface 1140 and, assuming that host 1110 is Microsoft Windows oriented, a Win32 API 1120. Host 1110 may use a different operating system, in which case it would use a type of API that conforms to the used operating system. Briefly, Application Programming Interface (“API”) is a set of functions, procedures and/or protocols that an operating system (OS) provides to support requests made by computer programs. These “APIs” are generally called “system calls”.

Unlock Application Module 1110 may be an OS-compatible application that provides a user interface for a user using OS-based user interface API's. The OS may be, for example, Microsoft “Windows”, and the OS-compatible application may be implemented in any programming language (e.g., C++, C#, Java) by using any framework (e.g., Win32, .NET, Java VM). Win32 API 1120 is a connection layer between the user “space”/environment and the kernel “space”/environment. By “user space” is meant herein a memory area where user applications run. By “kernel space” is meant herein a memory area where kernel (OS) runs to provide services such as accessing various resources of the host's OS, drivers, Input/Output (“I/O”) devices, etc. Briefly, “kernel” manages, among other things, communication between hardware and software components. As a basic component of an OS, a kernel provides the lowest-level abstraction layer for the resources (e.g., memory, processors and I/O devices) that an application software must use in order to perform its function.

USB interface 1140 functionally intermediates between host 1100 and UFD 1160 and, as such, it uses a communication protocol that conforms to the specifications of UFD 1160. For example, USB interface 1140 may communicate with UFD 1160 using Small Computer System Interface (“SCSI”) 1142, or Human Interface Device (“HID”) 1132, or any other suitable transport layer. Briefly, “SCSI” is a set of standards for physically connecting and transferring data between computers and peripheral devices. SCSI standards define commands, protocols, and electrical and optical interfaces. The SCSI standard defines command sets for specific peripheral device types, and, by devising a suitable command set, the SCSI can interface with almost any device, for example with UFD 1160. Briefly, “HID” is a type of computer device that interacts directly with, and takes input from humans (e.g., from a keyboard or a computer mouse) and may deliver output to output devices.

In the USB architecture, computer peripherals are categorized into classes and a host can communicate with a peripheral device only if the host includes a proper class driver. For example, storage devices are classified as “mass storage”. Accordingly, host 1100 includes a class driver (i.e., USB Mass Storage Class Driver 1144) corresponding to the device's category (i.e., mass storage devices) of UFD device 1160 in order for host 1100 to be able to communicate with UFD device 11160.

USB Driver 1150 is a driver allowing interaction with UFD 1160. A “driver” is a computer program allowing higher-level computer programs to interact with a hardware device. A driver typically communicates with the hardware device through the computer bus or communications subsystem to which the hardware device is connected. Drivers are hardware dependent and operating system specific. In order to communicate with USB Driver 1150 (and in general with the UFD device 1160) there is a need to use system calls which connect between the user space and the kernel space.

UFD 1160 includes a USB Core 1170, second Unlock Application Module 1180, and a Lock Driver 1190. As explained above, UFD 1160 does not have a user interface. Therefore, UFD 1160 has to receive unlock codes from host 1100; i.e., through USB interface 1140 and USB Core 1170. As explained above, Unlock Application Module 1110 facilitates entering unlock codes by the user.

Responsive to entering an unlock code by the user of host 1100, for example by using a keypad of the host, Unlock Application Module 1110 hashes the unlock code, embeds, incorporates or encapsulates the resulting hash value into a standard USB command and, then, USB Driver 1150 sends the USB command (with the embedded, incorporated or encapsulated hash value) to UFD 1160. Upon receiving the USB command, USB Core 1170 parses the USB command to extract there from the embedded/incorporated/encapsulated hash value and sends the extracted hash value to Unlock Application Module 1180. Unlock Application Module 1180 compares the hash value to a hash value stored on a Non-Volatile Memory (NVM) of UFD device 1160 and if they match, meaning that the unlock code received from host 1100 is the correct unlock code, Unlock Application Module 1180 sends an unlock command to Lock Driver 1190 to unlock the anchor locked inside UFD 1160. Lock Driver 1190 translates the unlock command into corresponding electrical signal and sends the electrical signal to the locking mechanism to transition it from the “lock” state to the “unlock” state.

The locking mechanism described above (the locking mechanism is not shown in FIG. 11) may include a hardware alarm component that indicates the status of the tethering cable (i.e., “cut” or “uncut”). The hardware alarm component may reside within UFD 1160 and a processor of UFD 1160 may have a dedicated register (not shown in FIG. 11) which is associated with the hardware alarm component. The dedicated register can hold, at any given time, one of two values: a first value (e.g., “0”, “cut”), which is indicative of a cut cable, and a second value (e.g., “1”, “uncut”), which is indicative of an uncut cable. The value initially held in the dedicated register (i.e., the default value of the register) may be the “uncut” value. If the tethering cable is cut the hardware alarm component changes the value of the dedicated register from the initial “uncut” value to the “cut” value. UFD 1160 may have an alarm application for, or Unlock Application Module 1180 may take on, checking the value held by the dedicated register. Responsive to changing the value of the dedicated register to “cut”, the alarm application (or Unlock Application Module 1180) may activate or trigger a siren or perform some other predetermined operation, such as blocking access to data in UFD 11160.

### Tethering a Mobile Device

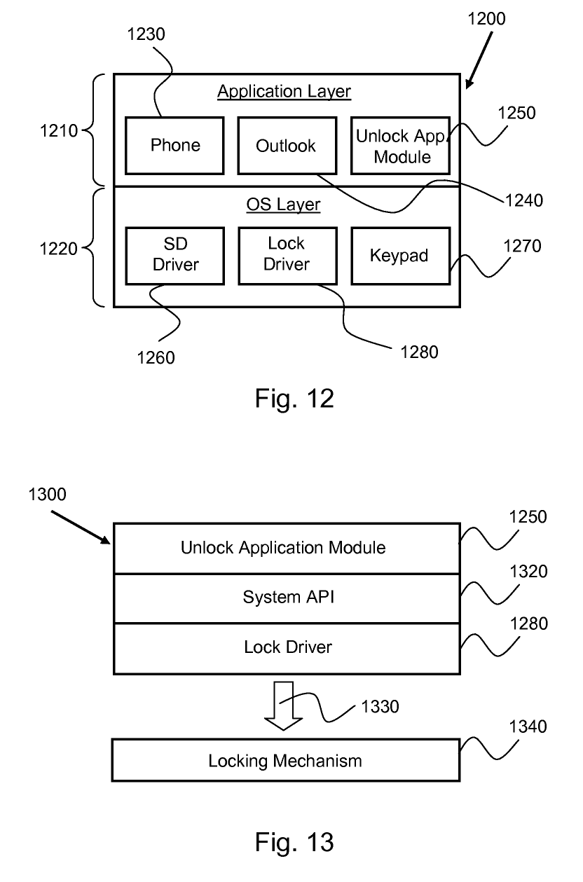

Referring again to FIG. 5, the tethered device (i.e., cell phone 550) has a user interface (e.g., keypad 551) by which the user can enter the unlock code. The anti-theft application, which may be, or include, an unlock application, wholly reside in cell phone 550. An exemplary phone OS architecture is shown in FIG. 12 and an exemplary phone unlock application stack is shown in FIG. 13. FIGS. 12 and 13 are described below.

FIG. 12 schematically illustrates a phone's OS architecture 1200 according to an example embodiment. Phone's OS architecture 1200 includes an application layer 1210 and an OS layer 1220. Cell phones generally operate using operating systems similar to operating systems of personal computers. For example, in advanced cell phones various phone applications associated, for example, with dialing/calling numbers, handling voice communications, handling calls log and address book (these type of applications are collectively shown as “Phone” 1230), run on the phone's OS like other traditional applications, such as “Outlook” 1240, calculator (not shown in FIG. 12), etc. Application layer 1210 also includes an unlock application module 1250 for executing the steps, procedures and methods associated with the operation of the locking mechanism described above. “Operation of the locking mechanism” generally includes entering unlock codes, verifying unlock codes, transitioning the locking mechanism from “lock” state to “unlock” state, detecting when a tethering cable is cut and issuing an alarm if the cable has been cut.

OS layer 1220 includes a Secure Device (“SD”) driver 1260, a keypad 1270, and a first lock driver 1280. OS layer 1220 may include additional drivers, such as a graphic adaptor driver, a microphone and speaker driver, a Wi-Fi antenna driver, etc. It is assumed that the cell phone subjected to OS structure 1200 is designed to use a memory card (e.g., an SD memory card). SD driver 1260 facilitates communication between application layer 1210 and such a card.

Keypad 1270, being the phone's user interface, allows the phone's user to enter alphanumeric data associated with the various traditional operations of the cell phone (dialing call numbers, sending text messages, browsing through “Outlook”, etc.). Additionally, keypad 1270 allows the user to enter unlock codes to unlock anchors. Lock driver 1280 is an interface allowing transferring an unlock signal to the locking mechanism, which unlock signal is initiated by unlock application module 1250.

FIG. 13 schematically illustrates a mobile phone's unlock application stack 1300 according to an example embodiment. FIG. 13 will be described in association with FIG. 12. Phone's unlock application stack 1300 includes the Unlock Application Module 1250 that is shown in FIG. 12, a system API 1320, and the lock driver 1280 shown in FIG. 12. Unlock application module 1250 uses system API 1320 to interact with keypad 1270 and lock driver 1280. For example, system API 1320 includes, or uses, a keypad's API (not shown in FIG. 13) that is used as described below.

In order to unlock an anchor and to untether the phone, the user enters an unlock code using keypad 1270. Keypad 1270 generates an electrical signal per keystroke, and the various keystroke signals associated with the entered unlock code are processed by the keypad's API, the result of the process being the unlock code being transferred to unlock application 1250. Unlock application 1250 compares the unlock code entered by the user to an unlock code stored on a NVM of the phone, and, if they match, interacts with lock driver 1280 to send an unlock signal 1330 to locking mechanism 1340 residing in the phone.

The OS's processor (not shown in FIG. 13) associates or maps locking mechanism 1340 with/to a dedicated register (which is referred to hereinafter as a “locking register”). The value held by the locking register represents the desired status of the locking mechanism; i.e., the locking register's value indicates whether the locking mechanism should remain “locked” or it should be “unlocked”. If unlock application module 1250 determines that an entered unlock code matches a pre-stored unlock code, it changes the value of the locking register from a value indicative of the “locked” state to a value indicative of the “unlock” state, to thereby signal to lock driver 1280 to unlock the locking mechanism. Unlock application module 1250 uses services rendered by system API 1320 to access the locking register (i.e., to change the register's value).

Hardware means may be used to associate or to map a hardware alarm component with/to a dedicated register (which is referred to hereinafter as an “alarm register”). The alarm register may be functionally connected to an OS event handling mechanism (not shown in FIG. 13), as cutting the tethering cable may be regarded as an “event” that should be handled one way or another.

The value held by the alarm register represents the current status of the tethering cable (i.e., “cut” or “uncut”). The alarm register may send its value to the OS each time its value changes, or unlock application module 1250 may request its value (e.g., by using a polling mechanism), for example periodically. If the hardware alarm component determines that the tethering cable has been cut, it changes the value of the alarm register from “uncut” to “cut”. Triggered by the change in the value of the alarm register to “cut”, unlock application module 1250 may activate or trigger a siren application or perform some other predetermined operation, such as blocking access to data in the mobile phone or selectively disabling some of the phone's functions.

In the description and claims of the present application, each of the verbs, “comprise”, “include” and “have”, and conjugates thereof, are used to indicate that the object or objects of the verb are not necessarily a complete listing of members, components, elements, or parts of the subject or subjects of the verb. The articles “a” and “an” are used herein to refer to one or to more than one (i.e., to at least one) of the grammatical object of the article, depending on the context. By way of example, depending on the context, “an element” can mean one element or more than one element. The term “including” is used herein to mean, and is used interchangeably with, the phrase “including but not limited to”. The terms “or” and “and” are used herein to mean, and are used interchangeably with, the term “and/or,” unless context clearly indicates otherwise. The term “such as” is used herein to mean, and is used interchangeably, with the phrase “such as but not limited to”.

Having thus described exemplary embodiments of the invention, it will be apparent to those skilled in the art that modifications of the disclosed embodiments will be within the scope of the invention. Alternative embodiments may, accordingly, include more modules, fewer modules, and/or functionally equivalent modules. For example, the locking mechanisms may be adapted to the type or model of the portable electronic device, and if the portable electronic device requires a host for operation the anti-theft functionality may functionally be distributed between the portable electronic device (e.g., a UFD) and the host (e.g., a PC). The present disclosure is, therefore, relevant to various types of portable electronic devices.

What is claim is:

1. A portable electronic device securable to an object, the portable electronic device comprising:
a locking mechanism, the locking mechanism comprising a socket, the locking mechanism being switchable between a locked position in which an anchor connected to the object is locked to the socket, and an unlocked position in which the anchor is not locked to the socket;
a user application code disassociated from said locking mechanism; and
a processor adapted to execute said user application code and an anti-theft application code, wherein executing the anti-theft application code facilitates receiving an unlock code and transitioning the locking mechanism into the unlocked position upon verifying the unlock code.

2. The portable electronic device according to claim 1, wherein the locking mechanism further comprises a latch for implementing the locked position and the unlocked position.

3. The portable electronic device according to claim 1, wherein the locking mechanism further comprises a latch, the latch being adapted to be actuated by the anchor for effecting the locked position.

4. The portable electronic device according to claim 1, wherein the portable electronic device is selected from the group consisting of laptop computer, personal digital assistance (“PDA”), media player, USB flash drive, portable data storage, digital camera, mobile phone, and text messenger.

5. The portable electronic device according to claim 1, wherein the processor receives the unlock code via a user interface of the portable electronic device.

6. The portable electronic device according to claim 1, wherein the processor receives the unlock code from a host device hosting the portable electronic device.

7. The portable electronic device according to claim 1, wherein the processor receives the unlock code via a communication network.

8. A portable electronic device having an anti-theft functionality and a user-operable useful functionality, the portable electronic device comprising:
a locking mechanism, the locking mechanism comprising a socket; and
a processor for executing the user-operable useful functionality and the anti-theft functionality,
wherein operation of the anti-theft functionality includes (i) locking an anchor in the socket to thereby secure the anchor to the portable electronic device, the anchor being connectable to an object separate from the portable electronic device, and (ii) unlocking, by said processor, the anchor from the socket upon receiving a valid unlock code.

9. The portable electronic device according to claim 8, wherein the anti-theft functionality may be operated before, during, or after execution of the user-operable useful functionality, and irrespective thereof.

10. The portable electronic device according to claim 9, wherein the locking mechanism further comprises a latch that is adapted to be actuated by the anchor to lock the anchor in the socket.

11. An anti-theft system for securing a portable electronic device that has an anti-theft functionality and a user-operable useful functionality, the anti-theft system comprising:
a) an anchor adapted to be retained to an object separate from the portable electronic device;
b) a locking mechanism, the locking mechanism being part of the portable electronic device, the locking mechanism comprising a socket for securing said anchor, to thereby secure said anchor to the portable electronic device; and
c) a processor that is part of the portable electronic device, for executing the user-operable useful functionality and the anti-theft functionality,
wherein executing the anti-theft functionality includes unlocking, by said processor, the anchor from the socket upon receipt of a valid unlock code from the portable electronic device, and wherein the anti-theft functionality may be operated before, during, or after execution of the user-operable useful functionality, and irrespective thereof.

12. The anti-theft system according to claim 11, wherein the anchor has a retention portion that is rigidly connected to, or is part of, the separate object.

13. The anti-theft system according to claim 11, wherein the anchor has a retention portion that is securable to the separate object by means of a cable.

14. The anti-theft system according to claim 13, wherein the cable includes an electric wire to facilitate monitoring of the cable's physical integrity.

15. The anti-theft system according to claim 14, wherein an alarm is issued by the user-operable useful functionality responsive to the electric wire being cut off or damaged.

16. The anti-theft system according to claim 14, wherein responsive to the electric wire being entirely cut off, the portable electronic device triggers an alarm and electronically locks itself.

17. The anti-theft system according to claim 14, wherein responsive to the electric wire being damaged the portable electronic device electronically locks itself and displays a message that an attempted theft occurred.

18. The anti-theft system according to claim 11, wherein the anchor has a retention portion that accommodates one cable end.

19. The anti-theft system according to claim 11, wherein the anchor has a retention portion that accommodates two cable ends.

20. The anti-theft system according to claim 11, wherein the anchor consists of a first part and a second part separate from the first part, the first part and the second part each having a retaining portion that is connectable to an end of a cable, the first part and the second part being adapted to be jointly engaged with, and to be jointly disengaged from, the socket.

21. The anti-theft system according to claim 20, wherein the retaining portion of the first part of the anchor is connected to a first end of a cable and the retaining portion of the second part is connected to a second end of the cable, and wherein the portable electronic device is secured to the stationary object by jointly engaging the first and second parts of the anchor with the socket such that the cable embraces the separate object.

22. The anti-theft system according to claim 11, wherein the processor receives the unlock code via a user interface that is part of the portable electronic device.

23. The anti-theft system according to claim 11, wherein the processor receives the unlock code from a host device that is functionally connected to the portable electronic device.

24. The anti-theft system according to claim 11, wherein the processor receives the unlock code via a communication network.

25. The anti-theft system according to claim 11, wherein securing the anchor to the socket is effected by the anchor actuating a latch while the anchor resides in the socket.

26. In a portable electronic device having an anti-theft functionality and a user-operable useful functionality disassociated from the anti-theft functionality, a method of using the portable electronic device, the method comprising:
a) operating the user-operable useful functionality;
b) using the anti-theft functionality, comprising:
i. inserting an anchor into a socket of the portable electronic device, the anchor being connected to an object separate from the portable electronic device;
ii. securing the anchor to the socket, thereby securing the anchor to the portable electronic device; and
iii. unsecuring the anchor from the socket upon verifying an unlock code that is received at the portable electronic device.

27. The method according to claim 26, further comprising activating an alarm upon receiving a predefined number of improper unlock code.

28. The method according to claim 26, wherein the anchor is connected to the object by a cable.

29. The method according to claim 28, further comprising monitoring the cable's physical integrity.

30. The method according to claim 26, wherein the unlock code is received via any one of a user interface of the portable electronic device or a communication network.

31. The method according to claim 26, wherein the processor receives the unlock code from a host device hosting the portable electronic device
